(19) United States
(12) Patent Application Publication
(10) Pub. No.: US 2008/0126133 A1
(43) Pub. Date: May 29, 2008

(54) Sharing Medical Information

(75) Inventor: Todd Park, Canton, MA (US)

Correspondence Address: PROSKAUER ROSE LLP, ONE INTERNATIONAL PLACE, BOSTON, MA, 02110, US

(73) Assignee: Athenahealth, Inc., Watertown, MA (US)

(21) Appl. No.: 11/771,285

(22) Filed: Jun. 29, 2007

Related U.S. Application Data
(60) Provisional application No. 60/818,181, filed on Jun. 30, 2006.

(51) Int. Cl. G06Q 50/00

(52) U.S. Cl. 705/3

(57) ABSTRACT

A healthcare professional (e.g., doctor, nurse, receptionist, medical billing administrator) can access a patient's workflow to add, delete, change, and/or approve of items associated with the workflow (e.g., refer patient to specialist, schedule an appointment, communicate patient information, add blood test, view blood test results). Another healthcare professional can access the patient's workflow to add, delete, change, and/or approve the items associated with the workflow (e.g., accept referral of patient, confirm appointment, communicate patient information, submit blood test results). The two healthcare professionals can communicate patient information (e.g., schedules, appointment information, insurance information, tests, test results, allergies, contact information) between each other.

### CROSS REFERENCE TO RELATED APPLICATIONS

This application claims the benefit of U.S. Provisional Patent Application No. 60/818,181, entitled “Method for Sharing of Medical Information,” filed on Jun. 30, 2006, the disclosure of which is hereby incorporated by reference.

### FIELD OF THE INVENTION

The present invention relates generally to methods and systems, including computer program products, for sharing medical information.

### BACKGROUND

Before the advent of networked systems and computers, medical patient workflow and billing was a manual process. Doctors, nurses, and receptionists used paper-based records to keep track of what tests a patient had undergone, what the patient's insurance would and would not cover, and how claims for healthcare items and/or services are to be settled. As computers became more prevalent and widely utilized, many medical practitioners used computers for electronic record keeping and billing statement generation.

With many medical practices, the number of patients that the practice serves fluctuates from day to day or season to season. As a result, the number and/or complexity of transactions that a medical practice management system processes for a given time period also fluctuates. These transactions, however, are important to the proper functioning of a medical practice management system. Examples of transactions include patient eligibility for a payment with respect to healthcare items and/or services, referral verification and approval, and claims processing transactions. When interacting with third-party payors such as insurance companies, it is often difficult to determine if the payors' processing system can handle a given volume of data that needs to be processed for the medical practice management system to function.

### SUMMARY OF THE INVENTION

One approach to sharing medical information is a method. The method includes accessing a patient workflow by a first user. A second user accesses the patient workflow. The first user and the second user communicate information associated with the patient workflow. The first user and/or the second user modify the patient workflow based on the information.

Another approach to sharing medical information is a computer program product. The computer program product is tangibly embodied in an information carrier. The computer program product includes instructions being operable to cause a data processing apparatus to access a patient workflow by a first user. A second user accesses the patient workflow. The first user and the second user communicate information associated with the patient workflow. The first user and/or the second user modify the patient workflow based on the information.

Another approach to sharing medical information is a system. The system includes a first medical practice module, a second medical practice module, and a workflow processing module. The first medical practice module is configured to access a patient workflow by a first user. The second medical practice module is configured to access the patient workflow by a second user. The workflow processing module is configured to communicate information associated with the patient workflow between the first user and the second user and modify the patient workflow by the first user and/or the second user based on the information.

Another approach to sharing medical information is a system. The system includes a means for accessing a patient workflow by a first user; a means for accessing the patient workflow by a second user; a means for communicating information associated with the patient workflow between the first user and the second user; and a means for modifying the patient workflow by the first user and/or the second user based on the information.

In other examples, any of the approaches above can include one or more of the following features. The first user approves a medical encounter performed by the second user. The information includes medical information, medical encounter information, insurance information, message information, appointment information, and/or referral information.

In some examples, the modifying the patient workflow includes adding, deleting, changing, and/or approving of an item associated with the patient workflow. The item includes a bill, an appointment, a referral, a test, an instruction, a message, and/or a task.

In other examples, the first user belongs to a group of healthcare providers and the second user does not belong to the group of healthcare providers. The group of healthcare providers includes healthcare providers associated with practice management software.

In some examples, the first user and second user both belong to a group of healthcare providers. The group of healthcare providers includes healthcare providers associated with practice management software.

In other examples, information associated with a patient who is associated with the patient workflow is communicated, utilizing a master patient index, to the first user and/or the second user. The master patient index includes an index associated with one or more patient information databases.

In some examples, a patient associated with the patient workflow requests or received a service from the first user and/or the second user. The service is associated with a medical encounter.

In other examples, the first user and/or the second user are associated with a healthcare professional. The patient workflow is accessed by the first user utilizing a first communication network and the patient workflow is accessed by the second user utilizing a second communication network. The first communication network and/or the second communication network are secure.

In some examples, a master patient index module is configured to communicate information associated with a patient who is associated with the patient workflow to the first user and/or the second user. A master patient index module is configured to modify the patient workflow based on information associated with a patient who is associated with the patient workflow.

Any of the aspects and examples above can provide one or more of the following advantages. An advantage is that the patient workflow can be dynamically updated based on the needs of a patient as determined by healthcare professionals (e.g., physicians, nurses) and/or healthcare facilities (e.g., nursing homes), thereby increasing the quality of care for patients. Another advantage is that patients can receive better care via the sharing of healthcare information among healthcare professionals and/or healthcare facilities. An additional advantage is that the cost of healthcare can be reduced through the communication of clinical information and/or administrative information associated with a patient.

Another advantage is that sharing medical information strengthens the hospital, physician, and patient relationship through increased communication. An additional advantage is that sharing medical information can increase the quality of referral information from primary care physicians to specialty physicians to improve information available to the specialists which thereby improves the quality of care for patients. Another advantage is that sharing medical information can decrease the costs associated with referrals and/or tests by improving the ease and flexibility involved with scheduling and/or communicating about medical encounters.

### BRIEF DESCRIPTION OF FIGURES

The foregoing and other objects, features, and advantages of the present invention, as well as the invention itself, will be more fully understood from the following description of various embodiments, when read together with the accompanying drawings.

FIG. 1 is a functional block diagram of an exemplary system illustrating sharing medical information.

FIG. 2 is a functional block diagram of an exemplary system illustrating a medical practice management server communicating with a medical practice network and a payor network.

FIG. 3 is a functional block diagram of an exemplary system illustrating a medical practice management server with a master patient index module.

FIG. 4 is an exemplary screenshot of a client interface in a medical practice module illustrating a patient's schedule.

FIG. 5A is an exemplary client interface in a medical practice module illustrating patient items.

FIG. 5B is an exemplary client interface in a medical practice module illustrating a physician modifying patient items.

FIG. 5C is an exemplary client interface in a medical practice module illustrating the submission of outbound tests for a patient.

FIG. 5D is an exemplary client interface in a medical practice module illustrating inbound test for a patient.

FIG. 5E is an exemplary client interface in a medical practice module illustrating tests for a patient.

FIG. 5F is an exemplary client interface in a medical practice module illustrating the results of inbound test results of a patient.

FIG. 6 is an exemplary flowchart depicting sharing medical information.

FIG. 7 is an exemplary flowchart depicting communicating patient information associated with a master patient index.

### DESCRIPTION

Automating medical practice workflow and billing presents difficulties in many aspects including installation of a system, processing the eligibility or other status information of patients, interacting with the workflow, with other health care providers, and within the constraints of payor requirements, as well as measuring the success of a practice once the workflow has been established. For example, whereas documents associated with a patient (e.g., a patient's medical charts) were previously provided physically (i.e., as “hard copies”) between health care providers (e.g., family practitioner to a hospital) now many patients' documents, charts, and medical history are available electronically. Typically charts are provided as images or facsimile (fax) documents. Many medical providers, however, lack the ability to integrate these documents into their existing practice workflow. Rather, the electronic documents are received and printed out for the health care provider, the electronic aspect simply replacing the means through which the documents are conveyed rather than the documents themselves.

In addition to the difficulties encountered when sharing documents, it is sometimes unmanageable to coordinate communication and workflows between medical care providers, especially when the health care providers are not part of the same healthcare network. For example, a specialist health care provider that is a member of Blue Cross/Blue Shield of Massachusetts may encounter difficulty treating a patient whose primary care physician is a member of only Harvard Pilgrim medical group because there is no means of communicating securely about the patient's care. A similar problem is presented when medical care providers use different automated workflow and billing systems associated with a medical practice. Typically, a medical provider using one system cannot communicate with the other health care provider or modify the second health care provider's patient information (e.g., when the patient has an operation performed).

In accordance with Applicant's technology, a healthcare professional can access a patient's workflow (e.g., refer patient to specialist, schedule an appointment, communicate patient information, add blood test, view blood test results) to add, delete, change, and/or approve the items associated with the workflow. Another healthcare professional can access the patient's workflow to add, delete, change, and/or approve the items associated with the workflow. The two healthcare professionals can communicate patient information (e.g., schedules, appointment information, insurance information, tests, test results, allergies, contact information) between each other. A healthcare professional (e.g., physician) and/or a healthcare facility can add, delete, and/or change items associated with a patient to allow for changes in the healthcare of the patient which advantageously allows for a patient workflow associated with the patient to be dynamically updated based on the healthcare needs of the patient.

For example, the general practice physician orders a referral to a radiologist and a referral to an internal medicine specialist. The scheduling coordinator (e.g., receptionist) for the radiologist's office accesses the patient workflow and adds an appointment for the patient (e.g., May 5). The scheduling coordinator for the internal medicine specialist accesses the patient workflow and adds an appointment for the patient (e.g., May 19). The adding of the appointments can be, for example, completed automatically by the medical practice management server after the submission of the referrals by the general practice physician. The general practice physician can associate, for example, a priority order to the referrals so that the patient can be scheduled for an appointment with the radiologist before the appointment for the internal medicine specialist (e.g., the radiologist appointment is on May 5 and the internal medicine specialist appointment is on May 19). The appointment information can be communicated, for example, to the patient and/or the general practice physician.

For example, the general practice physician orders an x-ray of a patient's abdomen and a referral to an internal medicine physician. The internal medicine physician examines the patient and determines that the patient does not need an x-ray of the abdomen, but needs a colonoscopy. The internal medicine physician modifies the patient's workflow by deleting the x-ray test and adding a colonoscopy test. After the colonoscopy, the internal medicine physician can communicate the results to the general practice physician by entering the test results into the patient's workflow. The general practice physician receives a message that the test results for the patient are available and/or accesses the patient's workflow to review the test results for the patient.

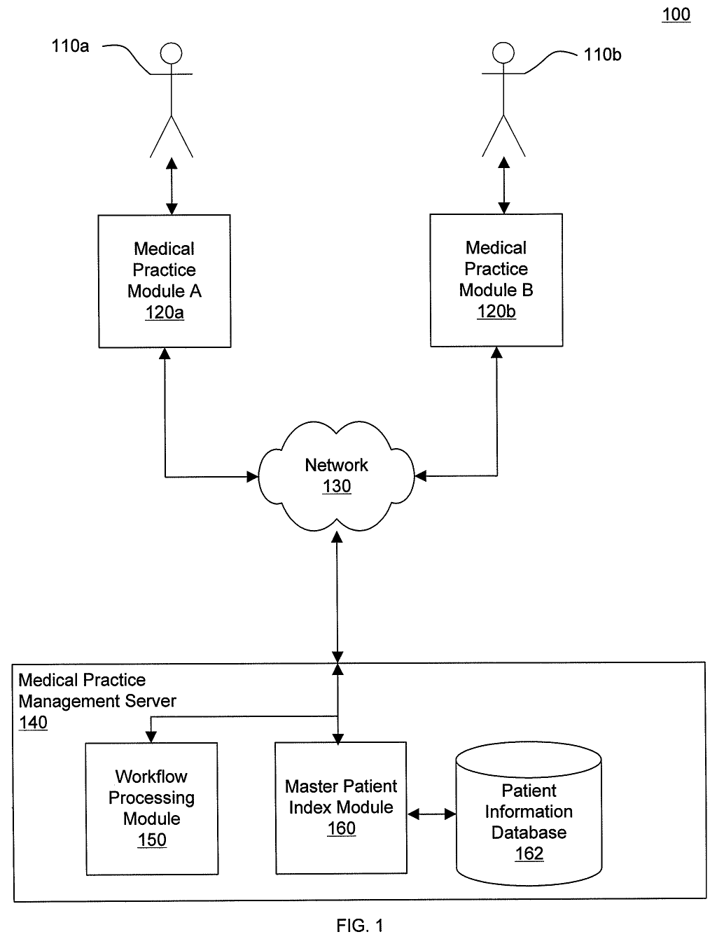

FIG. 1 is a functional block diagram of an exemplary system 100 illustrating sharing medical information. The system 100 includes a plurality of users 110a and 110b, a plurality of medical practice modules A 120a and B 120b, and a medical practice management server 140. The medical practice modules A 120a and B 120b communicate through a network 130. The medical practice modules A 120a and B 120b can communicate, for example, with each other and with the medical practice management server 140.

The medical practice management server 140 includes a workflow processing module 150, a master patient index module 160, and a patient information database 162. The workflow processing module 150 processes the workflows associated with a patient. The master patient index module 160 communicates with the patient information database 162 to access information associated with patients. The patient information database 162 includes information associated with the patients.

For example, a physician 10a utilizing a web application 120a executing on a desktop computer communicates through the network 130 (e.g., Internet, wide area network (WAN)) to the medical practice management server 140. The physician 110a inputs that patient Jane Smith is being referred to a dermatologist 110b for a skin rash that is 4 cm by 3 cm on the patient's left leg above the ankle—code R21. The referral information is communicated to the dermatologist 110b who accesses the referral information utilizing a web application 120b executing on a desktop computer through the network 130. The dermatologist 110b examines patient Jane Smith and adds examination results into the patient's workflow (e.g., skin rash, apply steroid cream twice daily, and recheck by physician in two weeks). The examination results are communicated to the physician 110a who reviews the examination results. The healthcare facility associated with the physician 110a can review the examination results and schedule a follow-up for the patient in two weeks.

In some examples, the network 130 is a WAN connecting a plurality of medical practice offices to the medical practice management server 140 and/or a medical practice management network. The network 130 can be, for example, a public communication network (e.g., Internet) and/or a private communication network (e.g., Intranet).

In other examples, the medical practice management server 140 is a web server hosting a web application that the user 110a utilizes to access a patient workflow and communicate with other users. The medical practice management server 140 can be, for example, an information interface that communicates information from a medical practice client application on a computing device 120a that the user 110a utilizes to access a patient workflow and communicate with other users.

Although FIG. 1 illustrates medical practice module A 120a and medical practice module B 120b communicating through the network 130, medical practice module A 120a can communicate, for example, through a first network and medical practice module B 120b can communicate, for example, through a second network. The first network and/or the second network can be, for example, a local area network (LAN) in the respective medical practice office, a wide area network (WAN) utilized by a plurality of medical practice offices, and/or any other type of communication network (e.g., public switched telephone network (PSTN)).

In other examples, the information communicated between users and/or the medical practice management server is medical information, medical encounter information, insurance information, message information, appointment information, referral information, and/or any other information associated with healthcare. A medical encounter can be, for example, any interaction and/or association with a medical professional, a medical facility, and/or a item related to medicine (e.g., medical website).

In some examples, the communication between users is secure. The secure communication can be, for example, between users at group practices and/or between users at a group practice and a non-group practice. The communication between users can be configured, for example, to comply with government regulations and/or laws regarding healthcare information (e.g., health insurance portability and accountability act (HIPAA)). Communications are associated with a patient workflow (e.g., approving a referral, a specialist recommending a test, providing patient history, and/or other communication associated with a patient workflow). The combination of the communications can form, for example, a virtual record of the patient that is shared between medical practices (e.g., group practice, non-group practice). For example, a virtual record includes the referral to a specialist, the tests requested by the specialist, and the test results. The creation and/or maintenance of the virtual record of the patient can advantageously allow, for example, compliance with government regulations and/or laws (e.g., HIPAA).

In other examples, a third user (not shown) accesses the patient workflow through a medical practice module C (not shown) via network C (now shown). The third user can modify, for example, the patient workflow. The first user 110a, the second user 110b, the third user, or any combination thereof can communicate information associated with the patient workflow between themselves.

In some examples, the patient (e.g., Jane Smith) accesses her patient workflow and/or modifies her patient workflow. The patient can, for example, view appointments, change appointments, request appointments, view test results, change patient information, change insurance information, and/or any other modification of the patient workflow.

In other examples, the patient (e.g., Jane Smith) can access her patient workflow and/or modify her patient workflow by utilizing a patient module. The patient module can be, for example, a reduced functionality interface to the medical practice management server (140). The patient module can, for example, provide an interface for the patient to view appointments, change appointments, request appointments, view test results, change patient information, change insurance information, and/or any other modification of the patient workflow.

In some examples, incorrect and/or incomplete information stored in the patient information database 161 is automatically updated per pre-defined rules (e.g., both sets of information stored and client is notified of the information discrepancy), updated per healthcare facility permissions (e.g., doctor can override a nurse), and/or other information updating procedures. For example, the first user 110a (e.g., receptionist) adds information associated with a patient (e.g., mailing address) to the patient information database 162 which is incorrect (e.g., wrong mailing address). The second user 110b (e.g., billing coordinator) inputs the correct information. The master patient index module 160 automatically updates the information based on the healthcare facility permissions that the second user 110b (e.g., billing coordinator) can override the inputs of the first user 110a (e.g., receptionist). Incorrect and/or incomplete information stored in the patient information database 161 can be, for example, updated by verifying the updated information with the user who inputted the incorrect and/or incomplete information and/or with the patient associated with the information. The verification can be, for example, by phone, mail, email, inputting a password, and/or any other verification method.

Although FIG. 1 illustrates workflow functionality via the workflow processing engine 150, other examples provide workflow functionality via a message passing interface (not shown). The message passing interface can be utilized, for example, to communicate between the users 110 and to modify the patient's workflow.

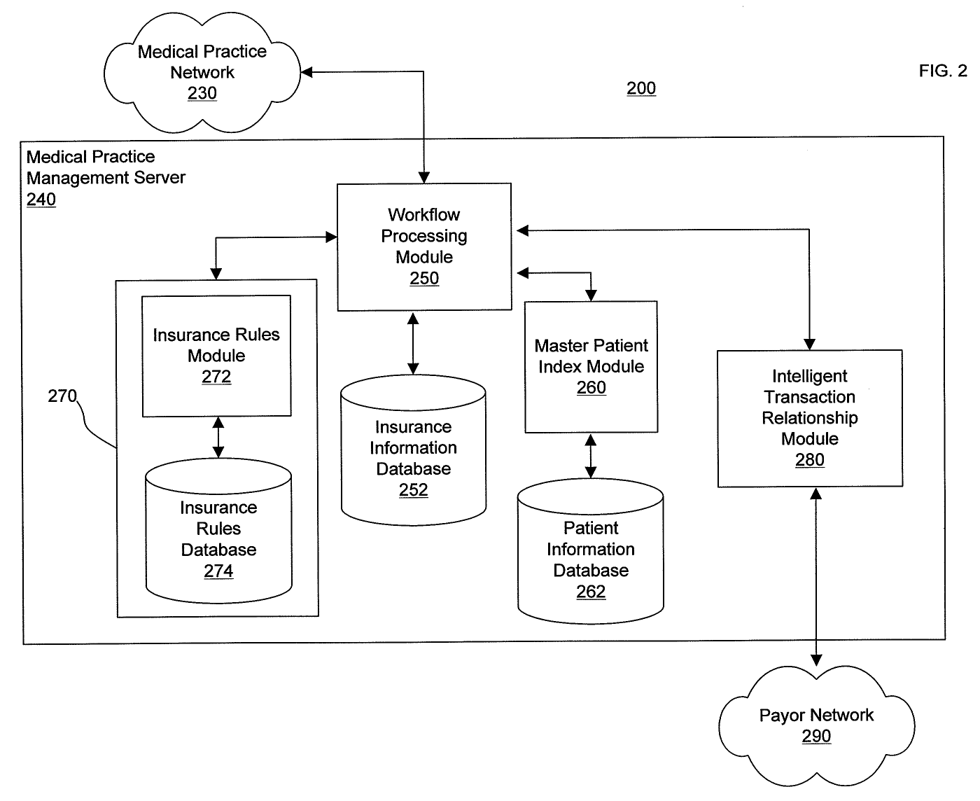

FIG. 2 is a functional block diagram of an exemplary system 200 illustrating a medical practice management server 240 communicating with a medical practice network 230 and a payor network 290. The medical practice management server 240 includes a workflow processing module 250, a rules module 270, and an intelligent transactions relationship (ITR) module 280. The rules module 270 includes an insurance rules module 272 and an insurance rules database 274.

The medical practice management server 240 includes a patient information database 262 and an insurance information database 252. The workflow processing module 250 stores part or all of the information associated with a patient in the patient information database 262. The patient information database 262 stores information associated with patients of the medical practice. The information can include, for example, the patient's address, phone number, zip code, height, weight, allergies, previous doctor(s), and/or other information associated with the patient.

In some examples, the workflow processing module 250, the rules module 270, and/or the ITR module 280 are software modules located within the medical practice management server 240. In other examples, the workflow processing module 250, the rules module 270, and/or the ITR module 280 are externally located from the medical practice management server 240 and communicate with the medical practice management server 240. In other examples, the rules module 270 includes a patient rules module (not shown) that processes rules associated with patients, and/or other types of rule modules that process rules associated with healthcare.

In some examples, the workflow processing module 250 is a software application that controls and manages the features and functions of the medical practice management server 240. The workflow processing module 250 and the medical practice module (not shown) communicate over the medical practice network 230. The medical practice module can transmit a medical care provider request containing information to the medical practice management server 240 using, for example, a common gateway interface (CGI) request. For example, when registering a new patient, a medical care provider operating the medical practice module enters the relevant patient information on a patient registration template that the workflow processing module 250 delivered to the medical practice client user interface (not shown).

In other examples, the workflow processing engine 250 validates the structure and composition of information entered by a medical care provider at the medical practice client to ensure that the information is correct (e.g., structure and/or composition). Examples of information entered by a medical care provider at the medical practice client include the patient's address, phone number, medical history, insurance information, diagnosis and procedure codes, and/or other information associated with a healthcare patient.

In some examples, the workflow processing engine 250 communicates with the rules module 270. The rules module 270 enables real-time application of “rules” stored in the rules database (not shown). A rule can be, for example, coded logic that evaluates data and then performs an action.

The rules module 270 can access and update, for example, information stored in the insurance rules database 274 using the insurance rules module 272. Although FIG. 2 illustrates the rules module 270 external to the workflow processing module 250, the rules module 270 can be, for example, a software layer internal to the workflow processing module 250. In some examples, the rules module 270 is implemented as an application program interface, a Component Object Model (COM) object, an Enterprise Java Bean, and/or any other type of database interface module.

The insurance rules database 274 and/or the interface to the insurance rules database 274 can be written, for example, in a structured query language. In some examples, the insurance rules module 272 uses a Lightweight Directory Access Protocol (LDAP) to access information in the insurance rules database 274. Additionally or alternatively, the insurance rules database 274 can be external to the medical practice management server 240 (e.g., distributed across three geographically dispersed data centers) or can be internally situated in the medical practice management server 240.

The insurance rules database 274 includes insurance company rules that define the appropriate format and content of clinical and claim information that the payor server (not shown) processes. In some examples, the rules are subdivided into various classes. For example, the rules are divided into rules that have universal applicability to all claims for a specified payor, rules that apply only to one or more specific insurance packages from among the variety of insurance packages that the payor offers to medical care providers, and/or rules that apply only to specific medical care providers who provide care under one or more specific insurance packages.

To ensure that the insurance rules database 274 contains current rules, the insurance rules database 274 can be, for example, frequently updated. In some examples, individual payors transmit rule updates/creations to the medical practice management server 240 via their payor server. Rule specialists can for example review the rules transmitted by the payor server and subsequently update the insurance rules database 274. In some examples, the rules specialist performs any and all updates to the insurance rules database 274. In other examples, the updating of the insurance rules database 274 can be automated upon receipt of a rule transmission from the payor server or the medical practice client.

In some examples, a medical care provider can submit information to the medical practice management server 240 for subsequent update of the insurance rules database 274 based on the medical care provider's experience with one or more payors. In other examples, the insurance rules database 274 is updated with the server's historical analysis of previously submitted claims, especially those that were denied, to identify the reasons for denial. The historical analysis of previously submitted claims can facilitate the development of new insurance rules for the insurance rules database 274.

In some examples, the medical practice management server 240 indexes the patient information stored in the patient information database 262 by the patient name. In other examples, the medical practice management server 240 indexes the patient information stored in the patient information database 262 with a patient identifier. The patient identifier can be, for example, a random number, a predetermined integer (such as a patient counter), the patient's zip code, the patient's phone number, and/or any other type of identifier associated with a patient. The workflow processing module 250 can access the patient information database 262 using, for example, a master patient index module 260.

In other examples, the workflow processing module 250 stores information associated with an insurance company in the insurance information database 252. The information associated with an insurance company includes the insurance company's address, the amount of insurance coverage for a particular patient, and/or other information associated with an insurance company. In some examples, the workflow processing module 250 can access the insurance information database 252 using an insurance information database module (not shown).

In some examples, as the workflow processing module 250 receives information from the medical practice client, the workflow processing module 250 determines on a real time basis whether all of the required information has been provided and/or whether the information is in the correct format. In the event that there is a deficiency and/or error in the information, the workflow processing module 250 alerts the medical care provider (e.g., receptionist), or user, for additional information and/or to correct the information. In other examples, the workflow processing module 250 corrects the defect and/or error.

For example, if the insurance rules module 272 contains a rule about member identification formatting for a particular payor, the insurance rules module 272 determines the rule in the insurance rules database 274 and communicates the information to the workflow processing module 250. The workflow processing module 250 communicates this information to the medical practice client when a medical care provider (e.g., receptionist) is registering a patient. If the medical care provider (e.g., receptionist) errs, the medical practice management server 240 alerts the medical care provider (e.g., with a warning message) to correct the error. This enables medical care providers to generate claims with no errors (i.e., referred to as clean claims) for the mutual benefit of the medical care provider and the payor. Additionally, the medical care providers can obtain the information associated with an alert while the patient is physically present (e.g., while the patient is still at the hospital, during their encounter, before checking out).

The workflow processing module 250 can be, for example, in communication with the ITR module 280. The ITR module 280 executes transactions sent to and/or received from the payor server via the payor network 290. Thus, the majority of provider/payor transactions can be accomplished electronically, with little or no human intervention. Examples of these transactions include, without limitation, claim submittals, claim receipt acknowledgements, claim status checks, patient eligibility determinations, authorization and referral requests and grants, and/or remittance advice. For example, a predetermined number of days before a scheduled patient visit, the ITR module 280 automatically checks patient eligibility with the applicable payor identified during the patient registration process. After a patient visit and the completion of the claim template, the claim is submitted to the payor server via the ITR module 280.

In some examples, upon receipt of an insurance claim, the payor transmits a confirmation back to the medical practice management server 240. Later, on a schedule determined by the medical care provider (e.g., weekly, monthly), the ITR module 280 checks the claim status and notifies the medical practice client accordingly. After the ITR module 280 analyzes the claim and generates remittance advice, the ITR module 280 parses the electronic payment and allocates the payment among the individual charge line items for the services provided. Once the medical care provider approves the allocations, the payments are posted to the provider's accounts.

In other examples, insurance rules database 274, insurance information database 252, and/or patient information database 262 are encrypted which advantageously complies with applicable laws and/or regulations. The information stored and/or associated with the medical practice management server 240 can be, for example, encrypted. The encryption of databases and/or information can be, for example, advanced encryption standard (AES), data encryption standard (DES), and/or any other type of encryption method and/or module. The encryption can be, for example, hardware based encryption and/or software based encryption.

In some examples, financial information is removed from the insurance rules database 274, insurance information database 252, patient information database 262, and/or any other information stored and/or associated with the medical practice management server 240. Part or all of the financial information can be, for example, removed and/or hidden (e.g., remove all but the last four digits of the social security numbers). The financial information can be, for example, removed from the primary database where the information is being stored (e.g., patient information database 262) and stored in a separate database. For example, the social security numbers are removed from all patient information stored in the patient information database 262 and placed in the secure patient information database (not shown). The information in the patient information database 262 and the secure patient information database can be associated with each, for example, by utilizing an assigned patient ID. The information in the secure patient information database can be secured, for example, utilizing a password, personal identification number, biometrics, and/or any other security mechanism. The financial information can include, for example, social security numbers, credit card numbers, bank account numbers, and/or any other information associated with finances.

Although FIG. 2 illustrates the modules insurance rules module 272, workflow processing module 250, master patient index module 260, and intelligent transaction relationship module 280 as separate modules, the modules 272, 250, 260, and 280 can be combined, for example, into one module or any number of modules. Similarly, the databases, insurance rules database 274, insurance information database 252, and patient information database 262 can be combined, for example, into one database and/or can be external or internal to the medical practice management server 240.

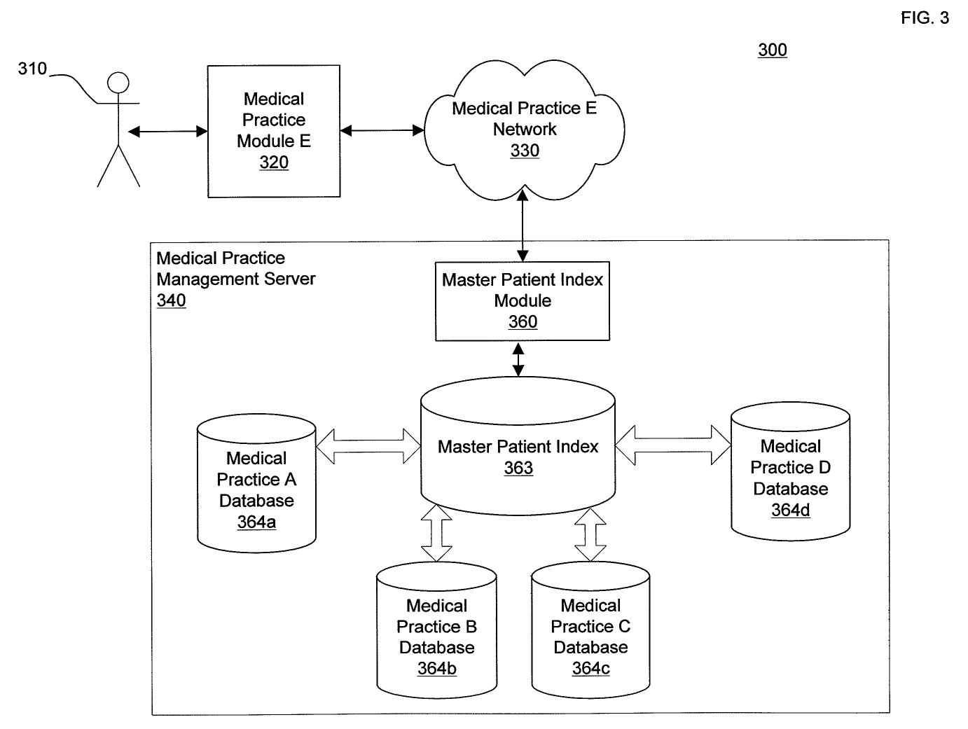

FIG. 3 is a functional block diagram of an exemplary system 300 illustrating a medical practice management server 340 with a master patient index module 360. The system 300 includes a user 310 utilizing a medical practice module E 320 which communicates via a medical practice E network 330 with the medical practice management server 340. The medical practice management server 340 includes the master patient index module 360, a master patient index 363, and medical practice database A 364a, B 364b, C 364c, and D 364d.

The user 310 (e.g., nurse, patient) requests information (e.g., allergies) associated with a patient through the medical practice module E 320 (e.g., Java application on a thin client computer). The medical practice module E 320 communicates through the medical practice E network 330 (e.g., cable modem connection to the Internet) to the medical practice management server 340. The medical practice management server 340 communicates (e.g., sends patient identification information and requested information) with the master patient index module 360 to request the information associated with the patient. The master patient index module 360 communicates via the master patient index 363 with the medical practice database A 364a, B 364b, C 364c, and D 364d to request the information associated with the patient. The master patient index module 360 merges the received information (e.g., allergic to penicillin from medical practice database A 364a and dust mites from medical practice database D 364d) and communicates the merged information (e.g., allergic to penicillin and dust mites) to the user 310 via the medical practice module E 320.

The master patient index 363 can form, for example, a patient record with data pulled from disparate data sources (e.g., general practice office in Boston and a cardiologist in New York City). The data sources can be, for example, logically segregated to prevent the commingling of a patient's data such that data is not shared with parties that are not intended to have access to it which advantageously complies with privacy regulations (e.g., HIPAA).

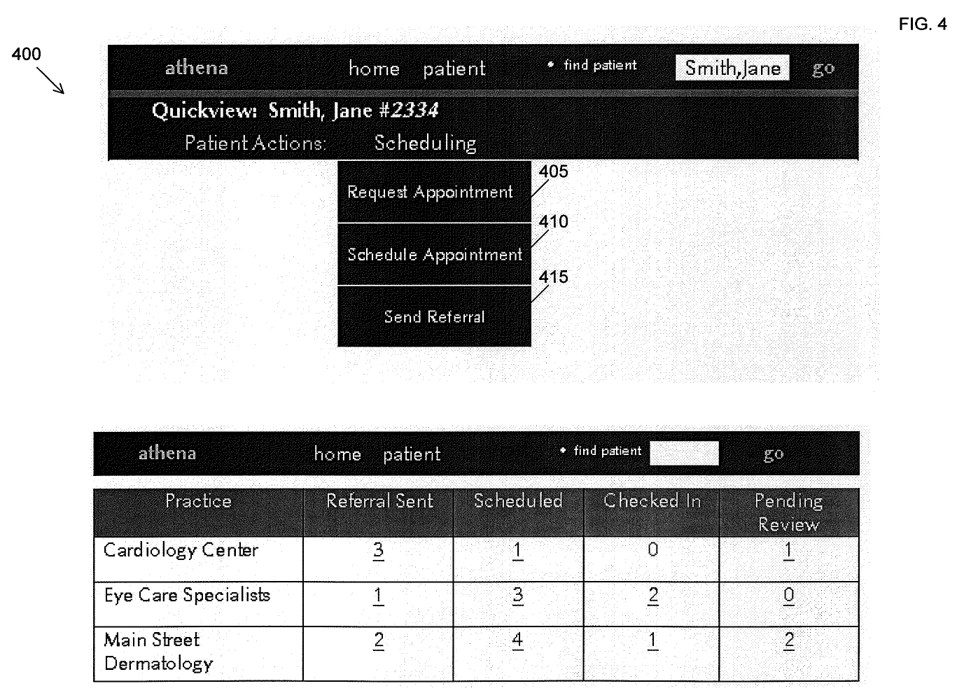

FIG. 4 is an exemplary screenshot 400 of a client interface in a medical practice module illustrating a patient's schedule. The client interface provides information associated with a patient and/or allows for workflow actions (e.g., adding tasks, deleting tasks, changing tasks, approving tasks) and/or messaging between both healthcare professionals and/or healthcare facilities.

Workflow actions include request an appointment 405, schedule an appointment 410, and send referral 415. Requesting an appointment 410 sends a notification, via the workflow processing module 150 in FIG. 1, to the requested medical practice. The requested medical practice receives the notification that an appointment has been requested. The requested medical practice then logs into the medical practice management server 140 and either schedules the appointment 410 or denies the appointment (not shown). If a referral is needed before an appointment can be requested, the medical practice management server 140 also provides medical practices with the ability to send a referral to another medical practice.

In some examples, sending a referral involves sending a notification, via the workflow processing module 150, to the desired medical practice. The desired medical practice receives the notification that a referral has been sent. The desired medical practice then logs into the medical practice management server 140 and acknowledges the referral.

In other examples, the acknowledgement of the referral automatically schedules an appointment for the patient. The automatic scheduling can include communicating, for example, a message to the patient and/or the referring practice. The message can include, for example, the next available time slot and/or the location of the referral medical office.

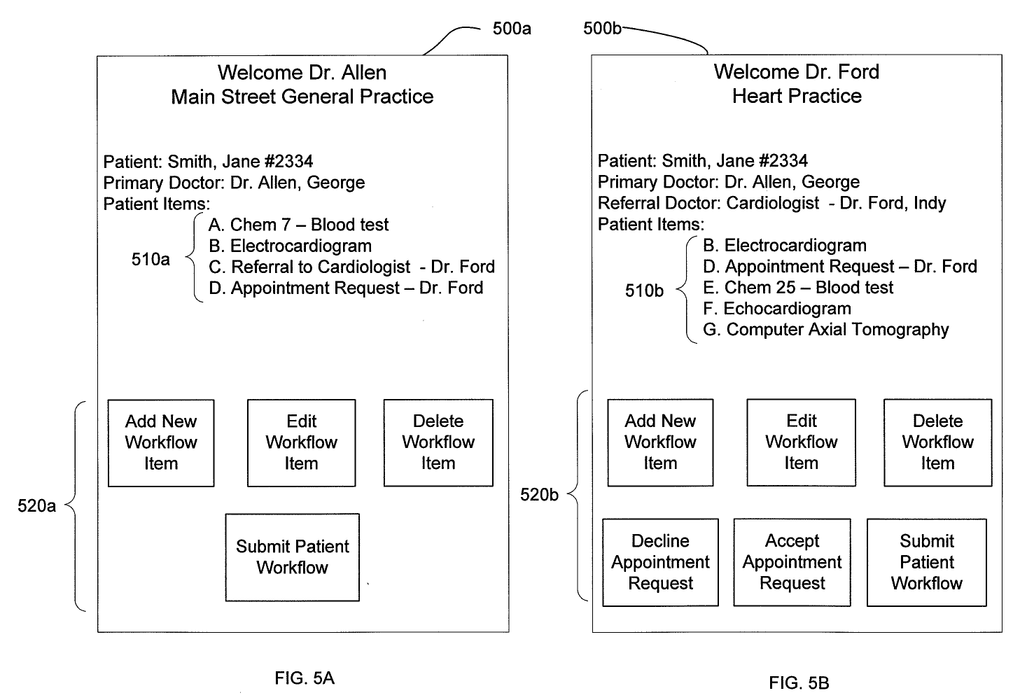

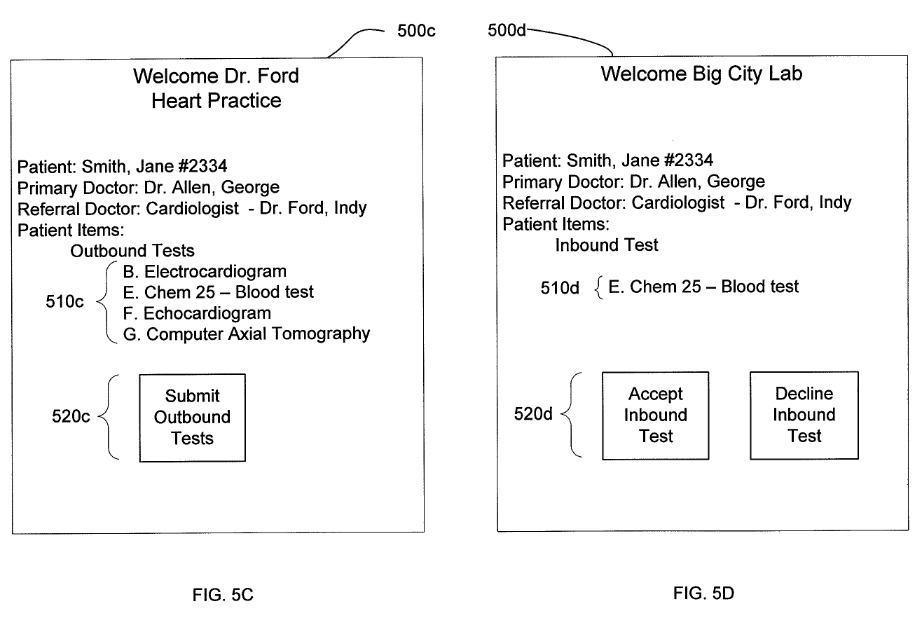

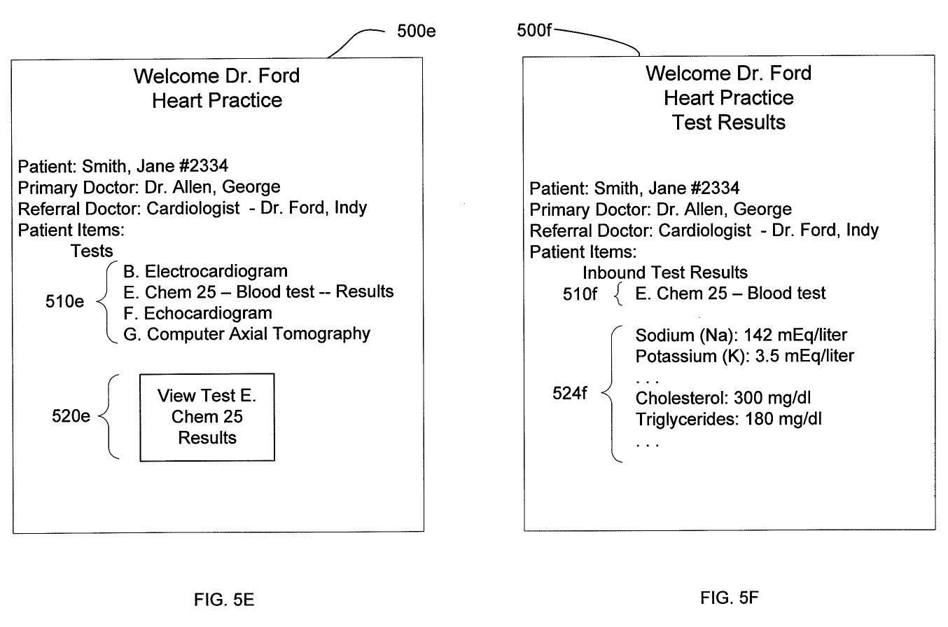

FIG. 5A is an exemplary client interface 500a in a medical practice module A 110a or B 10b illustrating patient tasks through the exemplary system 100 of FIG. 1. The client interface 500a includes patient items 510a and workflow actions 520a. The workflow actions 520a include add new workflow item, edit workflow item, delete workflow item, and/or submit patient workflow. The patient items 510a include medical encounters (in this example, Chem 7-blood test and electrocardiogram), referral information (in this example, Referral to Cardiologist—Dr. Ford), and/or other healthcare items (in this example, Appointment Request—Dr. Ford). The user utilizing the client interface 500a can, for example, utilize the workflow actions 520a to modify the patient workflow.

Patient items 510a can include, for example, tasks (e.g., lab tests, prescriptions for pharmacies), requests (e.g., referral request, appointment request), orders (e.g., medical procedures), and/or results (e.g., test results, medical procedure results, appointment request results).

FIG. 5B is an exemplary client interface 500b in a medical practice module A 110a or B 110b illustrating a physician modifying patient items through the exemplary system 100 of FIG. 1. The client interface 500b includes patient items 510b and workflow actions 520b. The workflow actions 520b include add new workflow item, edit workflow item, delete workflow item, decline appointment request, accept appointment request, and/or submit patient workflow. The patient items 510a include medical encounters (in this example, Chem 25-blood test, electrocardiogram and computer axial tomography).

FIG. 5C is an exemplary client interface 500c in a medical practice module A 110a or B 110b illustrating the submission of outbound tests for a patient through the system 100 of FIG. 1. The client interface 500c includes outbound tests 510c and workflow actions 520c. The outbound tests 510c include an electrocardiogram, a chem 25 blood test, an echocardiogram, and a computer axial tomography scan. The workflow actions 520c include submitting outbound tests for processing and/or testing.

In some examples, the outbound tests 510c include medical tests, lab tests, and/or any other type healthcare tests that a healthcare professional would sent out for processing and/or testing. In other examples, the workflow actions 520c include editing an outbound test, selecting who to send the outbound test to (e.g., Acme Labs, Sure Fire Testing Labs), selecting the time/date to send the outbound test (e.g., in 2 weeks, in one month), submitting the outbound test, and/or deleting the outbound test.

FIG. 5D is an exemplary client interface 500d in a medical practice module A 110a or B 110b illustrating an inbound test for a patient through the system 100 of FIG. 1. The client interface 500d includes inbound test 510d and workflow actions 520d. The inbound test 510d includes a chem 25 blood test. The workflow actions 520d include accepting the inbound test and/or declining the inbound test.

In some examples, the inbound tests 510d include a medical test, a lab test, a test referral, a new test appointment, an instruction associated with the patient, a bill for a test and/or any other type healthcare test a healthcare professional and/or a healthcare facility would receive for processing and/or testing. In other examples, the workflow actions 520d include editing an inbound item, declining the inbound item, and/or responding to the inbound item with test results and/or encounter results.

FIG. 5E is an exemplary client interface 500e in a medical practice module A 110a or B 110b illustrating tests for a patient through the system 100 of FIG. 1. The client interface 500e includes tests 510e and workflow actions 520e. The tests 510e includes an electrocardiogram, a chem 25 blood test, an echocardiogram, and a computer axial tomography scan. The workflow action 520e includes viewing the results of a test (in this example, the chem 25 blood test).

FIG. 5F is an exemplary client interface 500f in a medical practice module A 110a or B 110b illustrating the results of tests of a patient through the system 100 of FIG. 1. The client interface 500f includes an inbound test result 510f and test results 524f. The inbound test result 510f includes the chem 25 blood test. The test results 524f includes the results of the chem 25 blood test (in this example, Sodium (Na): 142 mEq/liter).

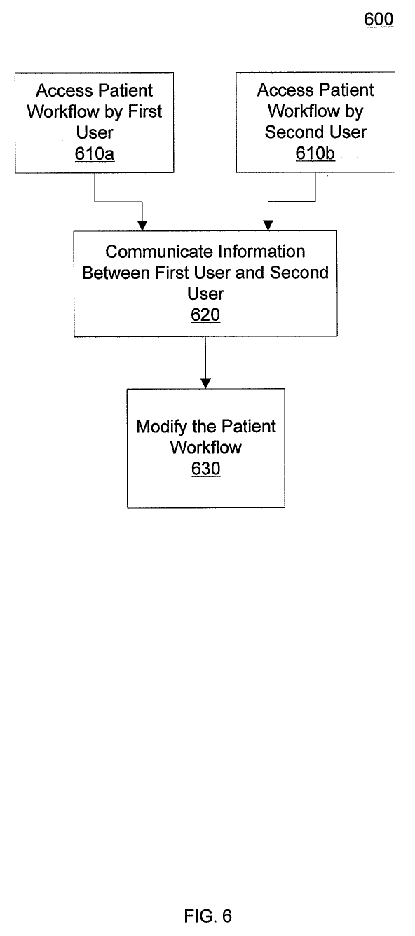

FIG. 6 is an exemplary flowchart 600 depicting sharing medical information through the exemplary system 100 of FIG. 1. A patient workflow is accessed (610a and 610b) by a first user 110a and a second user 110b, respectively. Information associated with the patient workflow is communicated (620) between the first user 110a and the second user 110b. The first user 110a and/or the second user 110b modify (630) the patient workflow.

For example, the first user, Dr. George Allen, 110a utilizes the client interface 500a of FIG. 5A in the medical practice module A 110a to access (610a) the patient workflow. The patient workflow is associated with the patient Jane Smith #2334. The patient workflow includes the patient tasks 510a associated with the patient Smith. Dr. Allen 110a accesses (610a) the patient workflow by viewing the patient tasks 510a. Dr. Allen 110a modifies (630) the patient workflow by adding the patient tasks 510a chem 7-blood test, electrocardiogram, and referral to cardiologist—Dr. Ford. Dr. Allen 110a then submits the patient workflow 520a to the workflow processing module 150. The workflow processing module 150 communicates (620) the patient information (in this example, Jane Smith #2334) and patient tasks to Dr. Ford 110b, the cardiologist to whom Dr. Allen 110a referred the patient.

Dr. Ford 110b accesses (610b) the patient workflow utilizing the client interface 500b of FIG. 5B in the medical practice module B 120b. Dr. Ford 110b modifies (630) the patient workflow by utilizing the workflow actions 520b. Dr. Ford 110b deletes the chem 7-blood test and adds a chem 25-blood test, an echocardiogram, and a computer axial tomography.

Dr. Ford 110b accesses (610b) the patient workflow utilizing the client interface 500c of FIG. 5C to identify the outbound tests 510c associated with the patient workflow. Dr. Ford 110b communicates the outbound tests 510c to the appropriate labs and/or testing facilities by utilizing the workflow actions 520c (in this example, submit outbound tests). The chem 25-blood test is communicated (similar to 630) to the Big City Lab testing facility (i.e., third user).

The Big City Lab testing facility accesses (similar to 610a and 610b) the patient workflow utilizing the client interface 500d of FIG. 5D. The inbound test 510d includes a chem 25-blood test for patient Jane Smith #2334. The Big City Lab testing facility has the option to accept or decline the inbound test as illustrated by the workflow actions 520d. The Big City Lab testing facility accepts the inbound test 510d for patient Jane Smith #2334. After completing the inbound test 510d for patient Jane Smith #2334, the Big City Lab testing facility modifies (similar to 630) the patient workflow by adding the test results for the chem 25-blood test.

Dr. Ford 110b accesses (610b) the patient workflow utilizing the client interface 500e of FIG. 5E to view the tests 510e associated with the patient workflow. Dr. Ford 110b can utilize the workflow actions 520e to view the chem 25-blood test results for patient Jane Smith #2334. After Dr. Ford 110b selects the workflow action 520e to view the blood test results, Dr. Ford utilizes the client interface 500f of FIG. 5F to view the blood test results 524f. The blood test results 524f include the information from the chem 25-blood test as analyzed by the Big City Lab testing facility.

In other examples, the users associated with a test are automatically sent results of the test. The test results can be sent, for example, via messaging, email, and/or any other type of message service (e.g., postal mail). For example, Dr. Ford 110b and/or Dr. Allen 110a are automatically sent the blood test results 524f in an email from the medical practice management server 140.

In some examples, the workflow tasks associated with a patient combine to form the services that a patient has received and/or requested from healthcare professionals. For example, the blood test is a workflow task that the doctor inputs and that the lab processes. Overall, the blood test is a service received by the patient from the healthcare professionals (in this example, doctor and lab).

Although FIG. 6 illustrates that the accessing (610a and 610b) of the patient workflow by the first user 110a and the second user 110b, respectively, occurs at or near the same time, the accessing (610a and 610b) can occur at different times/dates. For example, the first user 110a can access (610a) the patient workflow at 10:15 am on Monday from his medical office in Boston and the second user 110b can access (610b) the patient workflow at 1:23 am on Friday from her home office in Martha's Vineyard, Mass. The patient workflow can be, for example stored by the medical management practice server 140 which advantageously allows for electronic maintenance of patients records per applicable regulations and/or laws.

In some examples, the client interface for non-group practices, labs, and/or any other facility that needs reduced functionality is a client interface with reduced functionality. The reduced functionality allows the user, for example, to view, accept, and/or decline tasks associated with a patient workflow. The reduced functionality does not allow the user, for example, to edit, add, and/or change tasks associated with a patient workflow. The client interface with reduced functionality can be called, for example, a lite, light, and/or reduced client interface. The reduce functionality of client interfaces can increase, for example, security for the patient by restricting access to the edit, add, and/or change functionality of the system.

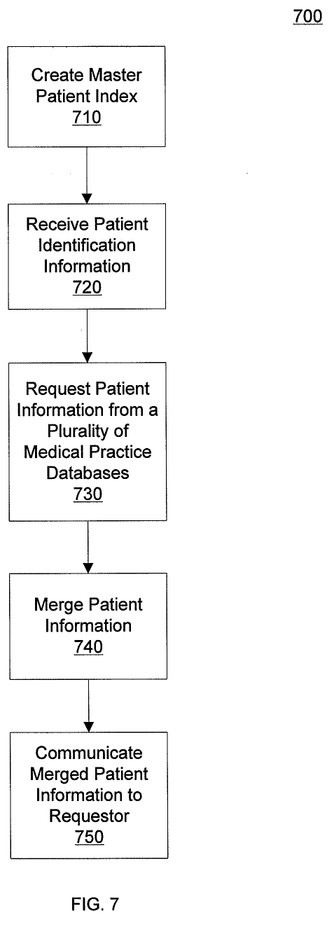

FIG. 7 is an exemplary flowchart 700 depicting communicating patient information associated with a master patient index 363 through the system 300 of FIG. 3. The master patient index 363 is created (710) by accessing the medical practice database A 364a, B 364b, C 364c, and D 364d (generally 364) to identify the patients that are associated with each medical practice. The master patient index 363 includes an index for each patient indicating which, if any, of the medical practice databases 364 includes information associated with each patient. The master patient index module 360 receives (720) patient identification information from a user 310 utilizing a medical practice module E 320. The master patient index module 360 requests (730) patient information from the medical practice databases 364 that have patient information as indicated by the master patient index 363. The master patient index module 360 merges (740) the received patient information. The merged patient information is communicated (750) to the requestor (in this example, the user 310).

For example, patient Jane Smith #2334 visited Medical Practice A regarding an allergic reaction to a bee sting. Medical Practice A (e.g., general practice medical office) stores the information that Jane Smith #2334 is allergic to bees in the medical practice database A 364a. Jane Smith #2334 also visited Medical Practice D (e.g., internal medicine office) regarding an infection. Jane Smith #2334 receives a shot of penicillin at Medical Practice D and has an allergic reaction to the penicillin. Medical Practice D stores information that Jane Smith #2334 is allergic to penicillin in the medical practice database D 364d. Jane Smith #2334 visits Medical Practice E (e.g., dentist) for a serious toothache. The user 310 (e.g., dentist, nurse, technician, receptionist) at Medical Practice E utilizes the medical practice module E 320 to request (730) patient information regarding Jane Smith #2334. The master patient index module 360 via the master patient index 363 receives the patient information from medical practice database A 364a and medical practice database D 364d which were indexed as the databases that included information associated with Jane Smith #2334 by the master patient index 363. The master patient index module 360 merges (740) the information regarding Jane Smith #2334 and communicates (750) the information, Allergies: Bees; Penicillin, to the user 310 through the medical practice module E 320.

In some examples, the master patient index module 360 analyzes information sent to the medical practice databases 364 and modifies the patient workflow based on information stored in the medical practice databases 364. For example, Jane Smith #2334 has information stored in the medical practice database D 364d that patient Smith is allergic to penicillin. When a user adds a workflow task to give a prescription of penicillin to patient Smith, the master patient index module 360 analyzes the prescription. The master patient index module 360 then modifies the workflow task for the prescription by placing a hold (e.g., redflag the prescription and not allow the prescription to be filled by a pharmacy) on the task. The master patient index module 360 can notify the user who added the workflow task for the prescription of penicillin and/or notify patient Smith regarding her allergy and prescription conflict.

In other examples, patient workflow rules are created based on information associated with the patient, information associated with a healthcare practice (e.g., general practice physician cannot create a task for an open heart surgery), and/or information associated with a healthcare professional (e.g., nurse cannot create a task for a x-ray). The patient workflow rules can be stored, for example, in a patient workflow rules database. The patient workflow rules can be created, for example, based on information communicated to/from one or more of the medical practice databases 364 and/or communication between the users. For example, if patient Smith is allergic to penicillin, then a rule can be created so that a prescription for penicillin for patient Smith cannot be created in the patient workflow. The patient workflow rules can be updated, for example, based on information sent to one or more of the medical practice databases 364 and/or communication between the users. For example, if patient Smith has a rule that a prescription for penicillin cannot be created in the patient workflow and patient Smith is also allergic to sulfonamides, then the no prescription rule for patient Smith can be updated to include both penicillin and sulfonamide based drugs.

In some examples, a modification (e.g., 630 of FIG. 6) of the patient workflow is verified by patient workflow rules. The patient workflow rules include determining if the user has permission to modify the patient workflow (e.g., the nurse cannot order a x-ray, the physician can order a x-ray), determining if the modification of the patient workflow corresponds with information associated with the patient (e.g., if a new prescription for a patient conflicts with the patient's allergy information), and/or other types of rules associated with the modification of the patient workflow (e.g., referral physician is over one hundred miles from patient's home address). If the modification violates one or more of the patient workflow rules, then the workflow processing module can, for example, prevent the modification of the workflow, notify the user (e.g., physician modifying the patient workflow), notify the patient, and/or prompt the user and/or the patient to allow the modification. For example, if Dr. Allen adds a prescription for penicillin to patient Smith's workflow, then the workflow processing module verifies the modification using the patient workflow rules. Since patient Smith has a patient workflow rule which does not allow the creation of prescriptions for penicillin, then the workflow processing module notifies Dr. Allen of patient Smith's allergy to penicillin and does not allow the prescription for penicillin to be added to patient Smith's patient workflow.

In other examples, a modification (e.g., 630 of FIG. 6) of the patient workflow is error checked to ensure that the modification does not contain errors (e.g., spelling error, dose error, referral error). If the modification of the patient workflow includes an error, then the workflow processing module can, for example, automatically correct the error, notify the user of the error, and/or notify the patient of the error. For example, if Dr. Allen adds a prescription for diazepam to patient Jane L. Smith's workflow, but patient Jane L. Smith does not exist in the patient information database, then the workflow processing module notifies Dr. Allen that patient Jane L. Smith does not exist. The workflow processing module can, for example, request information about all patients with the first name Jane and the last name Smith. The workflow processing module asks Dr. Allen which of patients with the first name Jane and the last Smith is the correct patient (e.g., Jane G. Smith, Jane P. Smith, Jane Smith).

In some examples, the information associated with Patent Smith #2334 is secured using a password and/or a personal identification number (PIN). For example, the user 310 of FIG>3 cannot access the patient's information without the patient providing and/or entering the protection mechanism (e.g., password, PIN) which advantageously protects the information associated with the patient and meets or exceeds privacy regulations and/or laws (e.g., HIPAA). The protection mechanism can protect, for example, information stored by other medical practices and/or information stored by the medical practice attempting to access the patient's information.

In other examples, a real-time or a near-real-time interface between a medical care provider and the medical practice management server 340 of FIG. 3, as well as other practices, create the master patient index 363. The master patient index 363 can be accessed, for example, by a medical practice (e.g., via a web browser). The medical practice can be, for example, a group medical practice, a non-group medical practice, a community medical practice, a specialty medical practice, and/or any other type of practice associated with medicine. Each medical practice subscribing to the medical practice management server 340 can retrieve, for example, a patient's demographic and/or insurance record from the medical practice management server 340 via the master patient index 363.

In some examples, retrieval of patient information is typically accomplished by sending a request record message (730) to the master patient index 363 (e.g., using a protocol such as HTTP and/or SOAP) providing information identifying a patient (e.g., by providing identifying information associated with the patient and/or a PatientID or a subscriber number associating the patient with an insurance providers).

In other examples, a pointer or silo model is used to protect a patient's confidentiality, thereby hiding information that may be protected by privacy regulations (e.g., HIPAA). In other examples, a peer-to-peer model is used to accomplish this hiding of information. The protection of a patient's confidentiality advantageously allows the system to comply with applicable privacy regulations and/or laws.

The master patient index 363 queries one or more medical practice information databases 364 to retrieve the requested information. In cases where the data is retrieved from different sources, the data can be, for example, combined and presented as a single, virtual patient record. The master patient index module 360 provides the record as a response message (e.g., via HTTP SOAP) that includes the requested information. In other examples, the information is provided as part or all of a web page and/or as an extensible markup language (XML) document.

Beneficially, in some examples medical practices (e.g., the users at the medical practices) are able to leave messages for and/or send messages to other medical practices. For example, Dr. Smith may include, as part of the information associated with the patient, a message to Dr. Jones regarding a test the patient needs performed. This message can be, for example, a text message that is associated with the patient's information and/or it may be a document and/or image (e.g., a Microsoft Word document, a fax, and/or image representing a scanned document from the first doctor addressed to the second doctor).

Sharing data between medical practices advantageously reduces the cost of duplicate patient and insurance registration between medical practices since only one record is stored, that single record accessible by all medical practices. Beneficially, this allows updates at one practice to be synched across the server, ensuring accurate and up to date information (e.g., new allergies, current medication). Further, providing interaction between practices eases implementation for new practices in the medical practice management by allowing the new practice to communicate and/or access information associated with the patients in a geographic region.

The medical practice module can be, for example, used by a medical care provider (e.g., healthcare provider, healthcare professional, healthcare facility). Examples of the medical care provider include, but are not limited to, medical physicians, medically trained individuals, medical specialists, medical experts, receptionists, professional associated with healthcare, and/or facilities associated with healthcare. The medical practice module can be, for example, located in a medical practice. In some examples, the medical practice is the office of the medical care provider (e.g., a doctor's office), a hospital, other facilities providing medical treatment, and/or the like. Although also referred to below as an insurance company, a payor organization can include, for example, health maintenance organizations (HMOs). Examples of payor organizations include, without limitation, Century Health and Benefits, HMO Blue, Harvard Pilgrim Health Care, MassHealth, Medicare, Neighborhood Health Plan, Tufts Associated Health Plan, United Healthcare, and the like.

Beneficially, many medical practices may utilize the same medical practice server via medical practice modules located at the respective medical practice locations. In some examples, providing service for multiple medical practices is achieved by providing data storage (e.g., databases and/or database tables, file systems, and the like) for each practice. For example, Dr. Smith, a dentist, may utilize the medical practice management server and Dr. Jones, an oral surgeon, who is not affiliated or associated with Dr. Smith, may also use the medical practice management server. Information associated with Dr. Smith's practice is stored in one practice database (e.g., medical practice A database 364a), while information associated with Dr. Jones' practice is stored in another database (e.g., medical practice B database 364b). In some examples, there is one database and the information associated with the respective doctors' practice is stored in separate tables. In other examples, the information associated with the respective doctors' practices is stored as different rows in the same database table.

Providing the server to multiple practices is mutually advantageous to the participating medical practices and the implementer of the system. The medical practices can communicate, for example, between each other via the medical practice management server and can modify the patient workflow of a patient common to each practice. Continuing the previous example, by both using the medical practice management server, Doctors Smith and Jones may easily refer patients between themselves, and/or approve tests recommended by the other, etc.

Additionally or alternatively, in some examples, the medical practice management server is operated as a subscription-based model, with pricing and/or support levels determined by a contract between the medical practice and the implementer and/or operator of the medical practice management server. In some examples, the full functionality of the server is provided, while other examples provide only limited functionality to certain medical practices (e.g., only batch processing of claims instead of real-time claim processing, twenty four-hour daily support versus sixteen hour, five days a week support, or other functional limitations).

In some examples, only a small amount of functionality is provided to those medical practices that do not subscribe to the medical practice management server service. Medical practices that subscribe to the service are typically referred to as “group practices.” Medical practices that do not subscribe to the service are usually referred to as “non-group practices.” Non-group practices can, for example, see patient records upon approval but cannot affect the patient workflow, or, where messaging capabilities are provided, leave messages for group practices. Other examples of the system provide mixed levels of service, and/or provide different levels of service to both group and non-group medical practices that are using the system (e.g., in some versions non-group practices can make changes to a patient workflow).

In some examples where various subscription levels are used to differentiate service, group practices are able to access specialty practices that also use the medical practice management server to schedule appointments, send demographic and insurance information to specialists, and/or attach referral information (e.g., test results, insurance information) for visits scheduled at the specialty medical practices. The association with practice management software can be used, for example, to differentiate the server between health care providers.

In other examples, the specialty practices themselves are group practices while in other examples, the specialty practices are non-group practices. The specialty practices can automatically, for example, receive the new patient's demographic, insurance, referral and/or appointment information via the master patient index. The specialist typically sends documentation of the visit back to the group practice, or alternatively or additionally, the specialty practice modifies the patient workflow. Beneficially, the medical practice management server provides a closed-loop audit trail that tracks referral/appointment status since referrals, approvals, tests, and/or other workflow tasks within the patient workflow which advantageously allows the system to comply with applicable medical patient record regulations and/or laws.

In other examples that utilize subscription-based models, the medical practice management server provides a reduced functionality subscription to a non-group medical practice (e.g., a community practice). The non-group practice can login, for example, to the medical practice management server to search for patients in the master patient index. This allows the non-group practice to advantageously view patient demographic and insurance information, access modified workflow pages to send and receive appointment and referral requests, and/or access a modified status page to track the status of incoming or outgoing referral/appointment requests.

In some examples, the non-group practice accesses the medical practice management server using a web browser. The non-group practice provides authentication credentials to the medical practice management server and the medical practice management server determines, via business logic, the identity of the non-group practice. Upon determining that the non-group practice is not a subscriber (i.e., is a non-group practice) the medical practice management server provides a reduced functionality interface to the non-group practice.

In other examples, the reduced functionality interface is a web page where information and input areas provided to group practices are not provided to non-group practices (e.g., logic on the medical practice management server that creates the web page omits information from the generated web page before sending the page to the non-group practice). In some examples, business logic provides the non-group practice with a web page or web pages designed to be viewed by a non-group practice (e.g., the developer of the web page has omitted the information from the web page). Beneficially, in some examples, business logic limits what medical practices or medical practice personnel can see information about a patient. For example, an endocrinologist can not view information about an oral surgery patient of Dr. Jones without Dr. Jones' approval (e.g., utilizing a PIN and/or password, peer selection in the medical practice management server) and/or the patient's approval (e.g., utilizing a PIN and/or password).

In some examples, the master patient index is useful for interacting with medical clinics by sending workflow items and/or messages between group practices and non-group medical and clinical practices. In other examples, non-group practices access a modified workflow to view relevant clinical information about the patient and to order lab tests and view results. For example, a non-group hospital sends a blood sample to a group practice blood lab requesting that blood tests be performed on the sample. The non-group hospital creates a workflow task for the blood lab via the medical practice module and sends the workflow task to the blood lab. From the hospital's perspective the workflow item is an “outbound” workflow task since someone else will need to perform a service (e.g., examination, test, medical encounter) for the workflow task to be completed. From the blood lab's perspective, the workflow task is an “inbound” workflow task since the workflow task will be processed by the blood lab. From the medical practice management server's perspective, there is one workflow task (e.g., process blood work) which is passed from one practice to another.

In some examples, practices are provided with a list of incoming and/or outgoing workflow tasks for the practice. This list may be updated, for example, via interacting with a web page displayed in a web browser, to reflect a change in the status and/or completion of a workflow task. The inbound and outbound workflow task can also be, for example, referrals, appointment scheduling requests, requests for recommendations, instructions from one health care provider to another, and/or consults. The blood lab can choose to accept or deny the workflow item request and if the request is accepted, the blood lab performs the necessary tests. Once the lab work done, the blood lab submits an outbound workflow task to the hospital, providing the results of the tests. Beneficially, the master patient index provides a closed loop audit trail to track patient workflow (e.g., ordering and performing lab orders and obtaining lab result status).

In some examples, the medical practice module (e.g., 320, 110a) can be any computing device, personal computer, Windows-based terminal, network computer, wireless device, information appliance, RISC Power PC, X-device, workstation, mini computer, main frame computer, personal digital assistant, and/or other computing device that has a windows-based desktop. In other examples, the medical practice module (e.g., 320, 110a) can connect to a network and has sufficient persistent storage for executing a small, display presentation program (e.g., Java applet, CGI enable web page). Windows-oriented platforms supported by the medical practice module (e.g., 320, 110a) can include, for example and without limitation, Windows 3.X, Windows 95, Windows 98, Windows NT 3.51, Windows NT 4.0, Windows 2000, Windows XP, Windows Vista, Windows CE, Windows Mobile, Mac/OS, OS X, Java, Unix, and/or Linux. The medical practice module can include, for example, a visual display device (e.g., a computer monitor), a data entry device (e.g., a keyboard), persistent or volatile storage (e.g., computer memory) for storing downloaded application programs, a processor, and/or a pointing device such as a mouse or digitized pen.

In other examples, the medical practice module includes a medical practice client user interface. The medical practice client interface can be, for example, text driven (e.g., DOS) and/or graphically driven (e.g., Windows). In some examples, the medical practice client user interface is a web browser, such as Internet Explorer™ developed by Microsoft Corporation (Redmond, Wash.), to connect to the medical practice management server. In other examples, the web browser uses the existing Secure Socket Layer (SSL) support, developed by Netscape Corporation, (Mountain View, Calif.) to establish the medical practice network as a secure network.

In some examples, the medical practice management server and/or the payor server can be any personal computer. In another example, the medical practice management server hosts one or more applications that the medical practice module can access (e.g., employee time entry, medical database). The medical practice management server can be, for example, part and/or associated with a server farm (e.g., a logical group of one or more servers that are administered as a single entity).

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device and/or in a propagated signal, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

The components of the system can be interconnected by any form or medium of digital data communication (e.g., a communication network). Examples of communication networks include a LAN, WAN, the Internet, wired networks, and/or wireless networks.

The networks can be, for example, a wireless network and/or a wired network. The networks can be, for example, a packet-based network and/or a circuit-based network. Packet-based networks can include, for example, the Internet, a carrier internet protocol (IP) network (e.g., LAN, WAN, campus area network (CAN), MAN, home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The computing device can include, for example, a computer, a computer with a browser device, a telephone, an IP phone, a mobile computing device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a Blackberry®.

Doctor and physician are open ended and include any type of healthcare professional referred to as a doctor and/or a physician. Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method of sharing medical information comprising:
accessing a patient workflow by a first user;
accessing the patient workflow by a second user;
communicating information associated with the patient workflow between the first user and the second user; and
modifying the patient workflow by the first user, the second user, or both based on the information.

2. The method of claim 1, further comprising approving, by the first user, a medical encounter performed by the second user.

3. The method of claim 1, the information comprises medical information, medical encounter information, insurance information, message information, appointment information, referral information, or any combination thereof.

4. The method of claim 1, the modifying the patient workflow further comprises adding, deleting, changing, approving, or any combination thereof of an item associated with the patient workflow.

5. The method of claim 4, wherein the item comprises a bill, an appointment, a referral, a test, an instruction, a message, a task, or any combination thereof.

6. The method of claim 1, wherein the first user belongs to a group of healthcare providers and the second user does not belong to the group of healthcare providers.

7. The method of claim 6, wherein the group of healthcare providers comprises healthcare providers associated with practice management software.

8. The method of claim 1, wherein the first user and second user both belong to a group of healthcare providers.

9. The method of claim 8, wherein the group of healthcare providers comprises healthcare providers associated with practice management software.

10. The method of claim 1, further comprising communicating, utilizing a master patient index, information associated with a patient who is associated with the patient workflow to the first user, the second user, or both.

11. The method of claim 10, wherein the master patient index comprises an index associated with one or more patient information databases.

12. The method of claim 1, wherein a patient associated with the patient workflow requests or received a service from the first user, the second user, or both.

13. The method of claim 12, wherein the service is associated with a medical encounter.

14. The method of claim 1, wherein the first user, the second user, or both are associated with a healthcare professional.

15. The method of claim 1, wherein the accessing the patient workflow by the first user utilizes a first communication network and the accessing the patient workflow by the second user utilizes a second communication network.

16. The method of claim 15, wherein the first communication network, the second communication network, or both are secure.

17. A computer program product, tangibly embodied in an information carrier, the computer program product including instructions being operable to cause a data processing apparatus to:
access a patient workflow by a first user;
access the patient workflow by a second user;
communicate information associated with the patient workflow between the first user and the second user; and
modify the patient workflow by the first user, the second user, or both based on the information.

18. A system for sharing medical information, the system comprises:
a first medical practice module configured to access a patient workflow by a first user;
a second medical practice module configured to access the patient workflow by a second user; and
a workflow processing module configured to communicate information associated with the patient workflow between the first user and the second user and modify the patient workflow by the first user, the second user, or both based on the information.

19. The system of claim 18, further comprising a master patient index module configured to communicate information associated with a patient who is associated with the patient workflow to the first user, the second user, or both.

20. The system of claim 18, further comprising a master patient index module configured to modify the patient workflow based on information associated with a patient who is associated with the patient workflow.

21. A system for sharing medical information, the system comprises:
a means for accessing a patient workflow by a first user;
a means for accessing the patient workflow by a second user;
a means for communicating information associated with the patient workflow between the first user and the second user; and
a means for modifying the patient workflow by the first user, the second user, or both based on the information.
